(19) United States
(12) Patent Application Publication
(10) Pub. No.: US 2015/0149067 A1
(43) Pub. Date: May 28, 2015

(54) KNOCKING CONTROL METHOD BASED ON SEPARATION LEARNING RANGE

(71) Applicant: Hyundai Motor Company, Seoul (KR)

(72) Inventor: Ha-Dong Bong, Gwangmyeong-si (KR)

(73) Assignee: Hyundai Motor Company, Seoul (KR)

(21) Appl. No.: 14/295,053

(22) Filed: Jun. 3, 2014

(30) Foreign Application Priority Data
Nov. 22, 2013 (KR) 10-2013-0142965

(51) Int. Cl. G01M 15/11

(52) U.S. Cl. CPC G01M 15/11
USPC 701/111

(57) ABSTRACT

A knocking control method based on a separation learning range may include (a) designating a learning cell in a driving range represented by a load-rotating number, (b) dividing the learning cell into individual cells, (c) designating a knocking cell of a partial load and a knocking cell of a full load, respectively, as other cells; and (d) determining a reference of a spark timing advanced and lagged angle by a difference between a partial load learning value of a high load and a learning value in the full load and based on the determined reference, simultaneously performing a knocking cell learning of the partial load and a knocking cell learning of the full load or not performing the knocking cell learning of the full load at the time of performing the knocking cell learning of the partial load.

### CROSS-REFERENCE TO RELATED APPLICATIONS

The present application claims priority of Korean Patent Application Number 10-2013-0142965 filed on Nov. 22, 2013, the entire contents of which application are incorporated herein for all purposes by this reference.

### BACKGROUND OF INVENTION

1. Field of Invention

The present invention relates to knocking learning, and more particularly, to a knocking control method based on a separation learning range capable of solving a vicious circle of knocking depending on mapping of a knocking learning control range by considering a partial load and a full load as a single Table even though spark timing setting types are different in the partial load and the full load.

2. Description of Related Art

Generally, knocking is a phenomenon that unburned end gas is auto-ignited before normal flame reaches an end of a combustion chamber, and in particular, an engine torque is reduced by generating spark timing prior to being advanced to a maximum brake torque (MBT) (the minimum advanced spark ignition at which a maximum torque is generated). The phenomenon may be deepened at the time of a low speed and a high load.

An example of preventing the knocking is a spark ignition data mapping type which makes an spark timing setting type be different based on a load to complete a spark ignition map depending on an engine RPM and a load. For example, there is a type of completing the spark ignition map by setting the spark timing depending on an RPM (Ne) and a load of the engine, determining, as a detonation board line (DBL), the spark timing when the knock does not occur in the engine operated depending on the set spark timing, and determining a spark timing in a specific RPM and a load by lagging the spark timing while having a margin for the DBL.

Unlike this, as the knocking learning, there is a more improved knocking learning control method based on a cell, which may solve a disadvantage of a method requiring time and manpower by an experiment.

The knocking learning control method is a method of mapping a knocking learning control range by dividing a driving range of the engine formed of the RPM and the load (air volume) into a learning cell, making the spark timing setting type be different in a partial load and a full load, and considering the partial load and the full load as a single Table.

For example, in the partial load, the spark timing is mapped to a value more lagged by 2 to 3° than the DBL (knocking occurrence spark timing), which is a normal driving range in which engine noise is not large at the time of the partial load and therefore is due to the mapping based on the noise. On the other hand, in the full load, the spark timing is mapped at the DBL or a level of DBL-1°, which is due to the mapping based on the large noise and power performance of the engine at the time of the full load.

In the division of the partial load and the full load, the knocking learning control is performed by dividing each driving range into a plurality of cells and applying the knocking learning cell. For example, when each driving range is divided into 16 cells which are divided into 0 to 15, the full load range is a type which covers cell No. 8 as the air volume 75 in 1200 to 2000 rpm.

However, the knocking learning control type which does not divide the differentiation of the spark timing setting type in the partial load and the full load maps the knocking learning control range by considering partial load and the full load as the single Table in the condition in which the spark timing setting types are different, such that any inconvenience occurs due to the coexistence of the partial load and the full load in the specific cell among the cells in which each driving range is divided.

As a result, the knocking occurs in the full load at the time of the knocking learning control and thus the lagged spark timing may be applied even in the partial load, such that the reduction in power performance may occur.

In particular, when the knocking does not occur in the partial load and thus the spark timing recovery is generated, in the case in which the driving is again made in the full load range while having the portion of the spark timing recovery, the vicious circle in which the knocking again occurs may occur.

Further, in the knocking learning control type, the knocking occurring at the load 75 or more at the time of the full load (e.g., throttle 70% or more) condition in a low land is learned in the specific cell and even though the knocking does not occur as the partial load up to the load 45 to 75 in the same range, the phenomenon that a learning value of the specific cell is lagged as a spark timing lagged value may occur.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is directed to a knocking control method based on a separation learning range capable of minimizing the occurrence of knocking in a full load with values learned in a partial load of a high load by applying a partial load knocking learning value of the same range even in a full load while dividing a knocking learning cell in the full load and the partial load, in particular, reflecting characteristics of the full load suitable for knocking by receiving and learning a partial load learning value as it is depending on performing the mapping while being more advanced such as by 2° than the partial load in the same range by learning a specific cell of the full load at the time of learning a specific cell value in the partial load.

In accordance with various aspects of the present invention, a knocking control method based on a separation learning range includes: (a) designating a learning cell in a driving range represented by a load-rotating number, (b) dividing the learning cell into individual cells, each of which corresponding to a unique number to be set in a partial load and a full load, respectively, (c) designating a knocking cell of a partial load and a knocking cell of a full load, respectively, as other cells, and (d) determining a reference of a spark timing advanced and lagged angle by a difference between a partial load learning value of a high load and a learning value in the full load and based on the determined reference, simultaneously performing a knocking cell learning of the partial load and a knocking cell learning of the full load or not performing the knocking cell learning of the full load at the time of performing the knocking cell learning of the partial load.

In the load-rotating number, the load may be divided into a plurality of throttle ranges each corresponding to an open value of a throttle, the rotating number may be divided into engine RPM ranges each corresponding to the throttle ranges, and the learning cell may be set to include cells each of which is assigned to a row and a column in which a corresponding throttle range and a corresponding engine RPM range are formed.

A cell other than the learning cell may be designated as an additional learning cell in the full load and the additional learning cell may be set as a knocking learning cell in the full load. The knocking learning cell in the full load may be applied to a full load condition in a low land.

The reference of the spark timing advanced and lagged angle may be set to be |the partial load learning value of the high load|≧|the learning value in the full load| or |the partial load learning value of the high load|<|the learning value in the full load|.

If the determined reference of the spark timing advanced and lagged angle is |the partial load learning value of the high load|≧|the learning value in the full load|, the method may further include determining whether a knocking occurs in the partial load of the high load, wherein, (A) if the knocking occurs, a spark timing lagged quantity may be simultaneously learned in a partial load knocking learning cell and a full load knocking learning cell, and (B) if the knocking does not yet occur, a spark timing advanced quantity may be learned in the partial load knocking learning cell or may not be learned in the full load knocking learning cell.

If the determined reference of the spark timing advanced and lagged angle is |the partial load learning value of the high load|<|the learning value in the full load|, the method may further include determining whether a knocking occurs in the partial load of the high load, wherein, (C) if the knocking occurs, a spark timing lagged quantity may be learned in a partial load knocking learning cell or may not be learned in a full load knocking learning cell, and (D) if the knocking does not yet occur, a determination on whether a spark timing lagged quantity>an advanced quantity based on mapping is performed, wherein, (D-1) if the spark timing lagged quantity>the advanced quantity based on mapping is satisfied, a spark timing advanced quantity may be simultaneously learned in the partial load knocking learning cell and the full load knocking learning cell, and (D-2) if the spark timing lagged quantity>the advanced quantity based on mapping is not yet satisfied, the spark timing advanced quantity may be learned in the partial load knocking learning cell or may not be learned in the full load knocking learning cell.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A and 1B are an operational flowchart of an exemplary knocking control method based on a separation learning range according to the present invention.

FIG. 2 is a diagram of a learning cell of a rotating number-load for applying an exemplary knocking control based on separation learning for each load according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Components are conceptually illustrated in the accompanying drawings to describe a concept of the present invention and a description of known components among the components will be omitted.

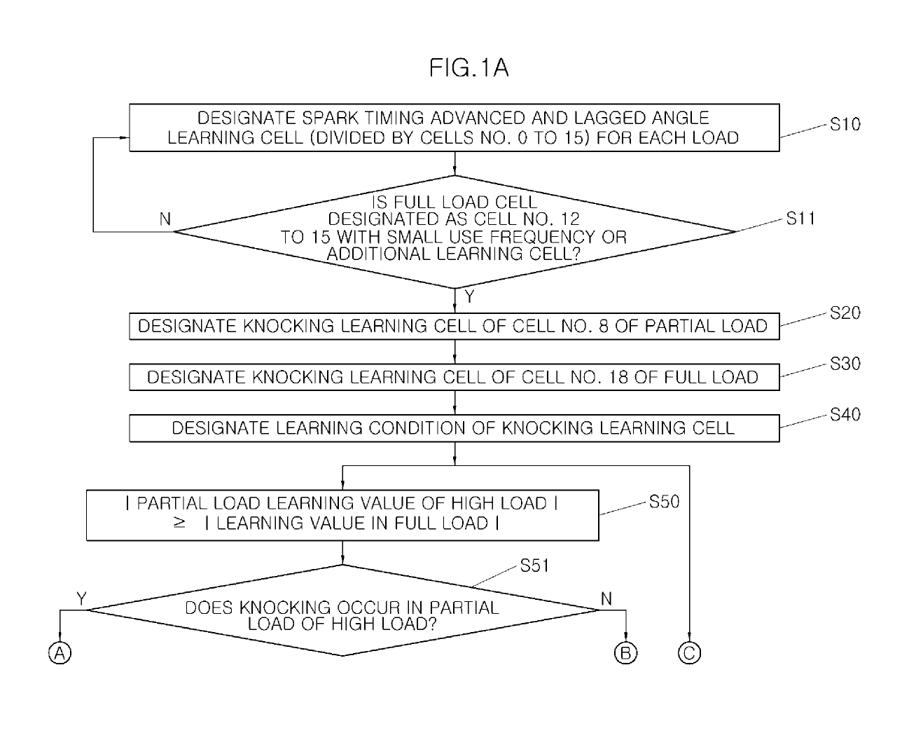

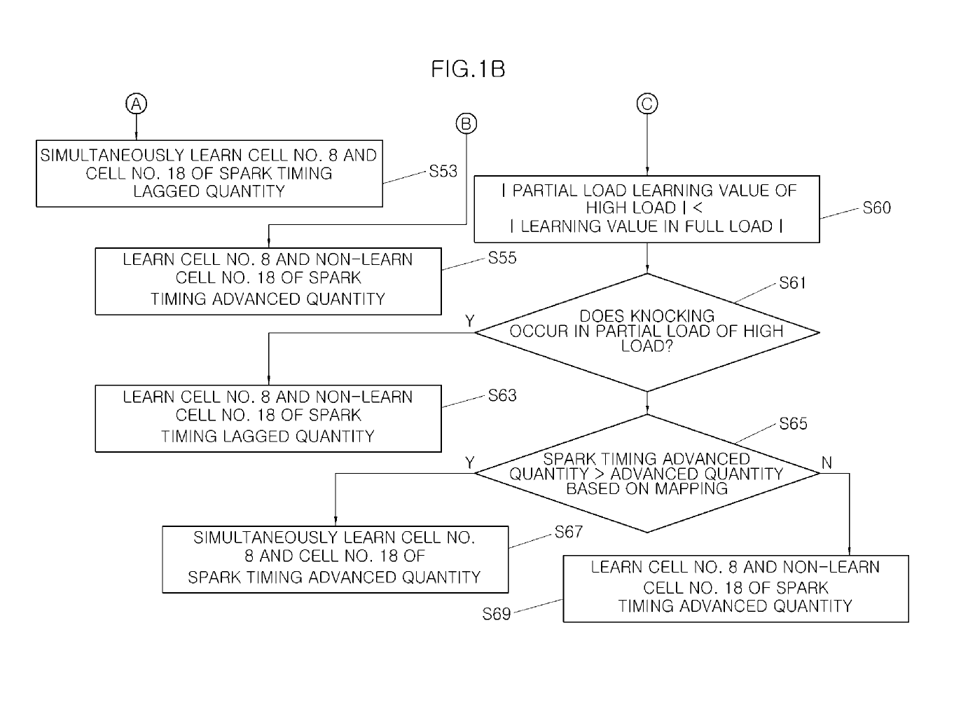

FIGS. 1A and 1B are an operational flowchart of a knocking control based on a separation learning range according to various embodiments of the present invention. In S10, an advanced angle and a lagged angle of spark timing are divided for each load and are designated as a learning cell. In this case, as in S11, it is checked whether a full load related learning cell is designated as a cell with a small use frequency or an additional learning cell which is not included in the learning cell.

According to various embodiments of the present invention, a load is divided into a plurality of ranges by an open value of a throttle, a rotating number is divided into engine RPM ranges each corresponding to the throttle ranges, and the learning cell is set to cells each of which is assigned to a row and a column in which the throttle range and the engine RPM range are formed. In particular, when a cell other than the learning cell is designated as an additional learning cell in the full load, the additional learning cell may be set as a knocking learning cell in the full load.

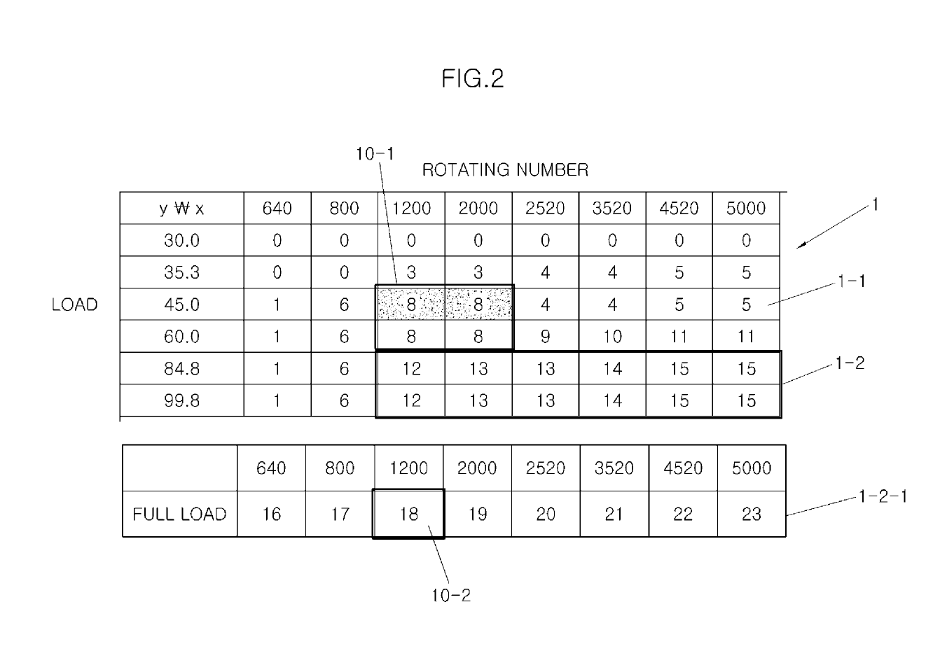

An example of the learning cell is illustrated in FIG. 2. As illustrated in FIG. 2, even though the learning cell is divided into about 16 learning cells from No. 0 to 15, the number and the learning range may each be different depending on a type of apparatuses.

As illustrated in FIG. 2, when learning cells 1 are classified into No. 1 to 15, each cell of No. 0 to 15 forming the learning cells 1 is designated as a unique range in a driving range represented by a load-rotating number.

For example, the load is divided into a range of 30.0, 35.3, 45.0, 60.0, 84.8, and 99.8, the rotating number is divided into a range of 640, 800, 1200, 2000, 2520, 3520, 4520, and 5000, and the learning cells 1 of No. 0 to 15 are a type of being designated in a row of the load and a column of the rotating number, respectively.

Therefrom, the cells of No. 0 to 11 with a large use frequency among the learning cells 1 are assigned to the partial load range to form a partial load learning cell 1-1 and the cells of No. 12 to 15 with the small use frequency among the learning cells 1 are mainly assigned to the full load range to form a full load learning cell 1-2.

However, the designation of the full load learning cell may be formed using a full load additional learning cell 1-2-1. For example, the full load additional learning cell 1-2-1 is designated as 16 to 23 cells, such that a rotating number 640 may be designated as cell No. 16, 800 may be designated as cell No. 17, 1200 may be designated as cell No. 18, 2000 may be designated as cell No. 19, 2520 may be designated as cell No. 20, 3520 may be designated as cell No. 21, 4520 may be designated as cell No. 22, and 5000 may be designated as cell No. 23.

In S20, the knocking learning cell for knocking learning among the partial load learning cells designated in S10 is designated. In this case, the partial load knocking learning cell 10-1 is designated as cell No. 8 as illustrated in FIG. 2.

In S30, the knocking learning cell for knocking learning among the full load learning cells designated in S10 is designated. In this case, in the full load (e.g., throttle 70% or more) condition in the low land and the load 75 or more, it is checked whether the occurrence condition of knocking is satisfied.

The full load knocking learning cell 10-2 is designated as cell No. 18 as illustrated in FIG. 2. Therefore, the cell No. 18 which is the full load knocking learning cell 10-2 may have a learning cell different from the cell No. 8 which is the partial load knocking learning cell 10-1.

As described above, the knocking learning cell is differently designated as the cell No. 8 cell and the cell No. 18, such that the knocking value occurring in the full load (e.g., throttle 70% or more) condition in the low land and the load 75 or more is stored in the cell No. 18 which is the full load cell not in the cell No. 8 by the learning. Therefore, the value of the cell No. 8 learned in the partial load is learned simultaneously with the cell No. 18 when being learned, thereby preventing the knocking from additionally occurring in the full load.

By using the characteristics, the full load is mapped by being more advanced such as by 2° than the partial load in the same range, such that receiving and learning the partial load learning value as it is may be suitable for the occurrence of knocking.

That is, when the knocking occurring in the full load (e.g., throttle 70% or more) condition in the low land and the load 75 or more is learned in the cell No. 8, the value means that even thought the knocking does not occur in the same range due to the partial load from the load 45 to 75, the control type lagged as a spark timing lagged value learned in the cell No. 8 is solved.

Meanwhile, S40 is a process of setting the learning condition of the knocking learning cell, which is set using the partial load learning value of the high load and the learning value in the full load.

As in S50, the learning condition of the knocking learning cell is set to |partial load learning value of high load|≧|learning value in full load|, as in S51, it is determined whether the knocking occurs in the partial load of the high load.

If it is determined that the knocking occurs by the check of S51, as in S53, the spark timing lagged quantity is simultaneously learned in the cell No. 8 and the cell No. 18. However, if it is determined that the knocking does not occur by the check of S51, as in S55, the spark timing advanced quantity is learned in the cell No. 8 but is not learned in the cell No. 18.

On the other hand, as in S60, the learning condition of the knocking learning cell is set to |partial load learning value of high load|<|learning value in full load|, as in S61, it is determined whether the knocking occurs in the partial load of the high load.

If it is determined that the knocking occurs by the check of S61, as in S55, the spark timing lagged quantity is learned in the cell No. 8 but is not learned in the cell No. 18. However, if it is determined that the knocking does not occur by the check of S61, the process proceeds to S65 to perform a determination on whether lagged quantity>advanced quantity based on mapping.

If it is determined that lagged quantity>advanced quantity based on mapping by the check of S65, as in S67, the spark timing advanced quantity is simultaneously learned in the cell No. 8 and the cell No. 18. However, if it is determined that spark timing lagged quantity>advanced quantity based on mapping by the check of S65, as in S69, the advanced quantity is learned in the cell No. 8 or is not learned in the cell No. 18.

As described above, in the knocking control method based on a separation learning range according to various embodiments of the present invention, the occurrence of knocking is minimized in the full load with values learned in the partial load of the high load by applying a partial load knocking learning value of the same range even in the full load while dividing a knocking learning cell in the full load and the partial load, the characteristics of the full load suitable for knocking is reflected by receiving and learning the partial load learning value as it is depending on performing the mapping while being more advanced by 2° than the partial load in the same range by learning a specific cell of the full load at the time of learning the specific cell value in the partial load, and in particular, the vicious cycle of the knocking may be completely solved depending on the mapping of the knocking learning control range by considering the partial load and the full load as the single Table even though the spark timing setting types are different.

According to various embodiments of the present invention, the vicious cycle of the knocking may be completely solved depending on the mapping of the knocking learning control range by considering the partial load and the full load as the single Table even though the spark timing setting types are different in the partial load and the full load, by performing the knocking learning cell division by the cell in the full load and the partial load.

Further, according to various embodiments of the present invention, the learning value of the knocking occurring at the load 75% or more at the time of the full load (e.g., throttle 70% or more) condition in the low land may be learned and stored by the learning cell different from the learning cell at the time of the partial load, by setting the full load range based on the addition of the learning cell or the cell with the small use frequency.

Further, according to various embodiments of the present invention, the characteristics of the full load suitable for the knocking may be reflected by receiving and learning the partial load learning value as it is depending on performing the mapping while being more advanced such as by 2° than the partial load in the same range by learning the specific cell of the full load at the time of learning the specific cell value in the partial load, in particular, the occurrence of the knocking in the full load may be minimized by simultaneously applying the values learned in the partial load of the high load to the learning cell of the full load.

Further, according to various embodiments of the present invention, the value learned in the knocking in the full load is reflected to the partial load to prevent the torque from reducing, such that the reduction in torque due to the difference in spark timing 2° by −2° to −3° which are the DBL at the time of the full load and the DBL at the time of the partial load may be recovered such as to 1 to 2%.

Further, according to various embodiments of the present invention, the active measures may be performed by changing the learning range in the high land in which the reduction in absolute load depending on the reduction in atmospheric pressure in the same throttle is essential.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A knocking control method based on a separation learning range, comprising:
(a) designating a learning cell in a driving range represented by a load-rotating number;
(b) dividing the learning cell into individual cells, each of which corresponding to a unique number to be set in a partial load and a full load, respectively;
(c) designating a knocking cell of a partial load and a knocking cell of a full load, respectively, as other cells; and
(d) determining a reference of a spark timing advanced and lagged angle by a difference between a partial load learning value of a high load and a learning value in the full load and based on the determined reference, simultaneously performing a knocking cell learning of the partial load and a knocking cell learning of the full load or not performing the knocking cell learning of the full load at the time of performing the knocking cell learning of the partial load.

2. The knocking control method of claim 1, wherein in the load-rotating number, the load is divided into a plurality of throttle ranges each corresponding to an open value of a throttle, the rotating number is divided into engine RPM ranges each corresponding to the throttle ranges, and the learning cell is set to include cells each of which is assigned to a row and a column in which a corresponding throttle range and a corresponding engine RPM range are formed.

3. The knocking control method of claim 2, wherein a cell other than the learning cell is designated as an additional learning cell in the full load and the additional learning cell is set as a knocking learning cell in the full load.

4. The knocking control method of claim 3, wherein the knocking learning cell in the full load is applied to a full load condition in a low land.

5. The knocking control method of claim 1, wherein the reference of the spark timing advanced and lagged angle is set to be |the partial load learning value of the high load|≧|the learning value in the full load| or |the partial load learning value of the high load|<|the learning value in the full load|.

6. The knocking control method of claim 5, wherein if the determined reference of the spark timing advanced and lagged angle is |the partial load learning value of the high load|≧|the learning value in the full load|, the method further comprising:
determining whether a knocking occurs in the partial load of the high load, wherein,
(A) if the knocking occurs, a spark timing lagged quantity is simultaneously learned in a partial load knocking learning cell and a full load knocking learning cell, and
(B) if the knocking does not yet occur, a spark timing advanced quantity is learned in the partial load knocking learning cell or is not learned in the full load knocking learning cell.

7. The knocking control method of claim 5, wherein if the determined reference of the spark timing advanced and lagged angle is |the partial load learning value of the high load|<|the learning value in the full load|, the method further comprising:
determining whether a knocking occurs in the partial load of the high load, wherein,
(C) if the knocking occurs, a spark timing lagged quantity is learned in a partial load knocking learning cell or is not learned in a full load knocking learning cell, and
(D) if the knocking does not yet occur, a determination on whether a spark timing lagged quantity>an advanced quantity based on mapping is performed, wherein,
(D-1) if the spark timing lagged quantity>the advanced quantity based on mapping is satisfied, a spark timing advanced quantity is simultaneously learned in the partial load knocking learning cell and the full load knocking learning cell, and
(D-2) if the spark timing lagged quantity>the advanced quantity based on mapping is not yet satisfied, the spark timing advanced quantity is learned in the partial load knocking learning cell or is not learned in the full load knocking learning cell.
